(19) United States
(12) Patent Application Publication
(10) Pub. No.: US 2023/0060477 A1
(43) Pub. Date: Mar. 2, 2023

(54) FLEXIBLE LONG-LASTING CLEAN ENERGY POWER GENERATION DEVICE WITH SPONTANEOUS MOISTURE ABSORPTION

(71) Applicant: NATIONAL TAIWAN UNIVERSITY OF SCIENCE AND TECHNOLOGY, TAIPEI CITY (TW)

(72) Inventors: LI-HSIEN YEH, TAIPEI CITY (TW); MENGYAO GAO, TAIPEI CITY (TW); SHAW-HU YEH, TAIPEI CITY (TW)

(21) Appl. No.: 17/458,580

(22) Filed: Aug. 27, 2021

(51) Int. Cl. H01M 50/141; H01M 50/124; H01M 50/121; H01M 50/238

(52) U.S. Cl. CPC H01M 50/141; H01M 50/1245; H01M 50/121; H01M 50/238

(57) ABSTRACT

A flexible long-lasting clean energy power generation device with spontaneous moisture absorption is a multi-layer film structure including a hydrophilic support substrate, a conductive layer and a moisture absorbent layer. The conductive layer is coated on an outer side of the hydrophilic support substrate and has a first section and a second section, and the moisture absorbent layer is coated on the first section of the conductive layer, so that the flexible long-lasting clean energy power generation device is formed into an asymmetrical structure. The moisture absorbent layer captures moisture from the ambient environmental humidity, and the moisture forms a capillary pressure difference by a capillary action and an evaporation, so that water molecules and ions move from the wet area of the moisture absorbent layer to the dry area of the second section to form an electric potential difference.

### BACKGROUND

### Technical Field

The present invention generally relates to the technical field of clean energy. More particularly, the present invention relates to a novel flexible long-lasting clean energy power generation device with spontaneous moisture absorption that can absorb humidity spontaneously and achieve a long-lasting stable output of the generated power, while having the advantages of low cost and high efficiency.

### Description of Related Art

The world today is facing two severe challenges: energy crisis and environmental pollution. These two challenges have driven many international research teams to begin to devote themselves to the development of clean energy power generation devices that do not produce any chemical pollutants during the power generation process. In electrokinetic energy conversion, ions in the nanochannel are driven to produce a potential difference by the electrokinetic effect. Due to the simple operating principle, the electrokinetic energy conversion has been widely used, and such energy conversion uses a pressure gradient to drive the movement of anions and cations in a charged nanochannel, so as to generate the streaming potential and streaming current in the device, which can be used to drive the operation of external circuits.

As disclosed in U.S. Pat. No. 2019/0097257, an electrokinetic energy power generation method uses an external pressure field to drive water and ions in a microchannel to move, together with an evaporation effect to enhance a capillary force, so as to improve the system energy output. Although this method can improve the traditional electrokinetic energy power generation, the method still has the following four major disadvantages, resulting in the limitation of actual commercialization. 1. Most traditional electrokinetic energy power generation devices requires a mechanical pump to apply an external pressure gradient force (that is the mechanical energy inputted to the devices to work), so that even if this method can use the evaporation capillary force to enhance the electrokinetic energy output, the energy conversion efficiency is still very low (less than 4.2%), and the output energy is also very small (approximately in the scale of 10⁻¹⁰ W), which is completely unable to drive any electronic product. 2. This electrokinetic energy power generation method requires additional liquid-state electrolyte solution to fill the whole device. When the moisture in the device is evaporated and exhausted, the whole device will stop working, so that the long-lasting performance of this method and the tolerance in various environments are limited drastically. 3. The design of the microfluidic device of this method is complicated and usually requires the use of soft lithography or laser engraving technology to manufacture the microfluidic channel which incurs a high manufacturing cost and also limits the commercial use of this device and method. 4. This device has no flexibility, which greatly limits the actual application.

In fact, the use of evaporation-driven capillary action for the electrokinetic energy power generation has started to develop around 2017. However, although the evaporation-driven electrokinetic energy power generation method can use spontaneously generated capillary pressure to solve the problems of requiring additional pressure and resulting in a low conversion efficiency of the traditional electrokinetic energy power generation device. In fact, the short-circuit current (I_{SC}) of the present devices just falls into the scale of hundreds of nA, so that it is still necessary to improve the energy output efficiency. In addition, such devices still have two severe problems. 1. The system needs a steady continuous water source. 2. The system has no flexibility. The above two disadvantages also greatly limit the commercial applicability and the scope of application of the related devices.

Therefore, it will be a substantial breakthrough in the related industry to develop a long-lasting, high-efficiency, and flexible electrokinetic energy power generation device that generates power by evaporation and capillary action without requiring an additional water source. The team of the present invention gathered research experience and professional knowledge in this field to conceive and disclose a novel flexible long-lasting clean energy power generation device with spontaneous moisture absorption that can be highly applied in various low-energy electronic devices and wearable products.

### SUMMARY

Therefore, it is a primary objective of the present invention to provide a flexible long-lasting clean energy power generation device with spontaneous moisture absorption, and the device has the advantages of easy availability, simple and natural use, low cost, long-lasting effect, high-efficiency output and bendable function to realize the expectation of sustainable clean energy generation.

To achieve the aforementioned and other objectives, the present invention discloses a flexible long-lasting clean energy power generation device with spontaneous moisture absorption, which is a multi-layer film structure, comprising: a hydrophilic support substrate; a conductive layer, coated on outer side of the hydrophilic support substrate, and having a first section and a second section; and a moisture absorbent layer, coated on the first section of the conductive layer, wherein the flexible long-lasting clean energy power generation device is formed into an asymmetrical structure; thereby, the moisture absorbent layer captures moisture in the environment, and the moisture forms a capillary pressure difference by a capillary force and an evaporation, so that water molecules and ions moves from the wet area of the moisture absorbent layer to the dry area of the second section to form a potential difference. From the description above, it can be seen that the invention uses a moisture-absorbing material to capture the moisture from the ambient humidity, and finally uses the structure composed of the hydrophilic support substrate and the conductive layer coated onto the structure to achieve the spontaneous electrokinetic energy power generation effect in response to the effects of capillary action and evaporation, so as to effectively solve the problems of inconvenience and inflexibility that requires the process of applying an external pressure, and achieving an excellent power generation efficiency.

In addition, the present invention further discloses a flexible long-lasting clean energy power generation device with spontaneous moisture absorption, which is a multi-layer film structure, comprising: a hydrophilic support substrate; a conductive layer, coated on outer side of the hydrophilic support substrate, and having a first section and a second section; a moisturizing layer, coated on the first section of the conductive layer; a moisture absorbent layer, coated on an outer side of the moisturizing layer, so that the flexible long-lasting clean energy power generation device is formed into an asymmetrical structure; thereby, the moisture absorbent layer captures moisture in the environment, and the moisture forms a capillary pressure difference by a capillary action and an evaporation, so that water molecules and ions move from the wet area of the moisture absorbent layer to the dry area of the second section to form a potential difference. From the description above, it can be seen that the invention uses a moisture-absorbing material to capture the moisture from the natural environmental humidity and the moisturizing layer structure to store moisture and slow down the speed of moisture evaporation, and finally uses the structure composed of the hydrophilic support substrate and the conductive layer coated onto the structure to achieve the spontaneous electrokinetic energy power generation effect in response to the effects of capillary action and evaporation, and achieve an excellent power generation efficiency.

Preferably, the first section of an implementation mode has a length equal to 30˜35% of the length of the second section to achieve a better moisture absorption effect and a better power generation efficiency.

Preferably, the moisture absorbent layer of another implementation mode is made of a material selected from the group consisting of calcium chloride, bentonite, silicone, camphor wood and bamboo charcoal and they have the advantages of low price and easy availability.

Preferably, the moisturizing layer of another implementation mode is made of a metal-organic framework (MOF) material with the advantage of low price and capable of absorbing and maintaining more moisture from environmental humidity to achieve the long-lasting effect of a high electrokinetic power generation.

Preferably, the conductive layer of an implementation mode is made of a material selected from the group consisting of zero-dimensional carbon black particles, one-dimensional carbon nanotube, nano silver wire, or two-dimensional graphene and MXene in order to make the conductive layer have a better transmission performance and an easier access of the material.

Preferably, the hydrophilic support substrate of a further implementation mode is made of one selected from the group consisting of cellulose paper, cotton cloth and silk cloth in order to provide the required flexibility which is conducive to be used in wearable electronic devices in the future.

In summation, the present invention provides a novel long-lasting, high-efficiency spontaneous power generation device capable of absorbing moisture from the environment and generating electric power. As long as there is a source of humidity in the environment, this device can generate an endless supply of electric power. The key of success of this device resides on the design of the asymmetric film structure, and the hygroscopic material capable of endlessly capturing the moisture in the ambient humidity. Besides providing a certain degree of flexibility of the film, the hydrophilic support substrate can also form a micro nanochannel with the conductive material for the use of transmitting ions. In addition, the asymmetric film design will also be able to induce evaporation and capillary action due to the asymmetrical film design that always maintain the other side of the film dry, so as to enhance the electrokinetic energy power output performance. In order to maintain a stable humidity asymmetry at both sides of the asymmetric film, the present invention also provides a technical solution that adds a moisturizing layer and for the first time introduces a MOF material with hydrophilic and water-absorbing properties into the film moisture absorbent layer. The large specific surface area of the porous material is used to achieve the water retention effect, so s to provide a more stable and long-lasting electrokinetic energy power generation output. In addition, the electrokinetic energy power generation device of the present invention has the advantages of simple manufacture, easy availability and low cost of the material, and a power generation process not much limited by the environment, and not requiring additional water source or pressure gradient field. The invention can achieve a stable, long-lasting, high-performance power generation output in an environment from desert to oasis, and it is believed that this device has an extremely high commercial value for low-energy electronic equipment in the future.

### BRIEF DESCRIPTION OF THE DRAWINGS

FIG. 1 is a schematic view of a flexible long-lasting clean energy power generation device in accordance with a preferred embodiment of the present invention;

FIG. 2 is a cross-sectional view of a flexible long-lasting clean energy power generation device in accordance with a preferred embodiment of the present invention;

FIG. 3 is a schematic view showing an application of a flexible long-lasting clean energy power generation device in accordance with a preferred embodiment of the present invention;

FIG. 4 is a cross-sectional view of a flexible long-lasting clean energy power generation device in accordance with another preferred embodiment of the present invention;

FIG. 5A is a graph showing the change of experiment data of the open-circuit voltage (V_{OC}) outputted by a flexible long-lasting clean energy power generation device in accordance with a first structural mode of the present invention;

FIG. 5B is a graph showing the change of experiment data of the short-circuit current (I_{SC}) outputted by a flexible long-lasting clean energy power generation device in accordance with the first structural mode of the present invention;

FIG. 6A is a graph showing the change of experiment data of the open-circuit voltage (V_{OC}) outputted by a flexible long-lasting clean energy power generation device in accordance with a second structural mode of the present invention;

FIG. 6B is a graph showing the change of experiment data of the short-circuit current (I_{SC}) outputted by a flexible long-lasting clean energy power generation device in accordance with the second structural mode of the present invention;

FIG. 7A is a graph showing the change of experiment data of the open-circuit voltage (V_{OC}) outputted by a flexible long-lasting clean energy power generation device in accordance with a third structural mode of the present invention;

FIG. 7B is a graph showing the change of experiment data of the short-circuit current (I_{SC}) generated by a flexible long-lasting clean energy power generation device in accordance with the third structural mode of the present invention;

FIG. 8A is a graph showing the change of experiment data of the open-circuit voltage (V_{OC}) generated by a flexible long-lasting clean energy power generation device in accordance with a fourth structural mode of the present invention;

FIG. 8B is a graph showing the change of experiment data of the short-circuit current (I_{SC}) outputted by a flexible long-lasting clean energy power generation device in accordance with the fourth structural mode of the present invention;

FIG. 9A is a graph showing the change of experiment data of the open-circuit voltage (V_{OC}) outputted by a flexible long-lasting clean energy power generation device in accordance with a fifth structural mode of the present invention;

FIG. 9B is a graph showing the change of experiment data of the short-circuit current (I_{SC}) outputted by a flexible long-lasting clean energy power generation device in accordance with the fifth structural mode of the present invention;

FIG. 10A is a graph showing the change of experiment data of the successive short-circuit currents (I_{SC}) outputted by a flexible long-lasting clean energy power generation device of the fifth structural mode at different bending angles;

FIG. 10B is a graph showing the change of experiment data of the successive open-circuit voltages (V_{OC}) outputted by a flexible long-lasting clean energy power generation device of the fifth structural mode at different bending angles;

FIG. 11A is a graph showing the change of experiment data of the open-circuit voltage (V_{OC}) outputted by a flexible long-lasting clean energy power generation device of the fifth structural mode at different relative humidities;

FIG. 11B is a graph showing the change of experiment data of the short-circuit current (I_{SC}) outputted by a flexible long-lasting clean energy power generation device of the fifth structural mode at different relative humidities;

FIG. 12A is a graph showing the change of experiment data of the open-circuit voltage (V_{OC}) outputted by a flexible long-lasting clean energy power generation device in accordance with a sixth structural mode of the present invention; and

FIG. 12B is a graph showing the change of experiment data of the short-circuit current (I_{SC}) outputted by a flexible long-lasting clean energy power generation device in accordance with the sixth structural mode of the present invention.

### DESCRIPTION OF THE EMBODIMENTS

The accompanying drawings are included to provide a further understanding of the invention, and are incorporated in and constitute a part of this specification. The drawings illustrate embodiments of the invention and, together with the description, serve to explain the principles of the invention.

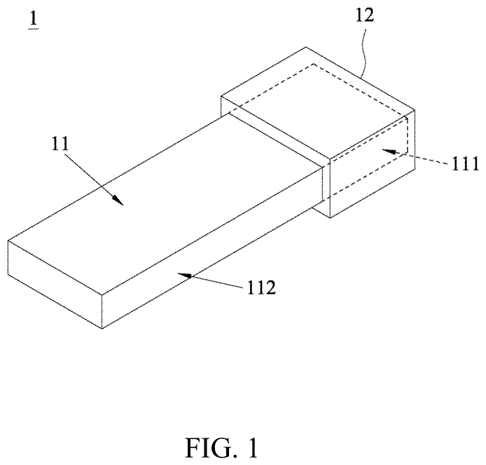

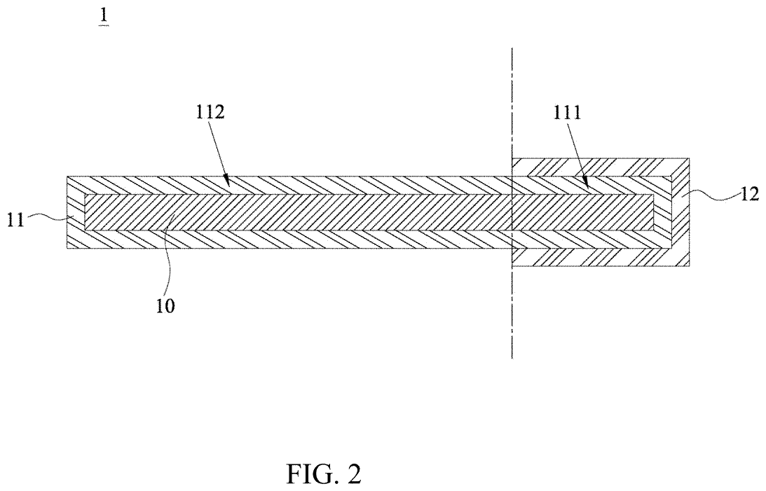

With reference to FIGS. 1 and 2 for the schematic views and cross-sectional view of a flexible long-lasting clean energy power generation device in accordance with a preferred embodiment of the present invention respectively, the structure drawn in the figure does not represent the actual thickness, length, width, or scale in order to help readers to clearly understand the technical characteristics of the present invention. In fact, the flexible long-lasting clean energy power generation device of the present invention is a film structure. The present invention discloses a flexible long-lasting clean energy power generation device with spontaneous moisture absorption 1, which is a multi-layer film structure, comprising: a hydrophilic support substrate 10, a conductive layer 11 and a moisture absorbent layer 12. The conductive layer 11 is coated on an outer side of the hydrophilic support substrate 10, wherein the conductive layer 11 has a first section 111 and a second section 112, and the first section 111 and the second section 112 are coupled and disposed adjacent to each other. The moisture absorbent layer 12 is coated on the first section 111 of the conductive layer 11, such that the flexible long-lasting clean energy power generation device 1 is formed into an asymmetrical structure. The moisture absorbent layer 12 captures moisture in the environment, and the moisture forms a capillary pressure difference due to the capillary action and evaporation, so that water molecules and ions move from the wet section of the moisture absorbent layer 12 towards the dry second section 112 to produce a potential difference. In an example as shown in FIG. 2, the flexible long-lasting clean energy power generation device 1 is a layered film structure in a laterally asymmetrical status. The main function of the right area having the conductive layer 11 and the moisture absorbent layer 12 is to absorb moisture in an environment, and the left area is the second section 112 of the conductive layer 11 with a relative dryness. The hydrophilic support substrate 10 can be made of any hydrophilic porous film material and used as a nanochannel for water transmission under the effect of evaporation and capillary action, wherein the hydrophilic support substrate 10 not just can direct the capillary action to generate capillary pressure to drive the movement of water and ions only, but also can be used as a flexible substrate, so that the flexible long-lasting clean energy power generation device 1 has the required flexibility. The conductive layer 11 can be made of any material with the conductive property and coated to form a film structure. Its function is to form a nanochannel with charges on the wall and the hydrophilic support substrate 10 in a water-containing environment, and provide the effect of converting electrokinetic energy for the transport of water and ions. The invention has the effects of providing external electrons, achieving the electric conduction function, and reducing the contact resistance between external electrodes. The moisture absorbent layer 12 has the ability to capture moisture from the atmospheric environment, and so as to form an asymmetric humidity on both sides of the flexible long-lasting clean energy power generation device 1.

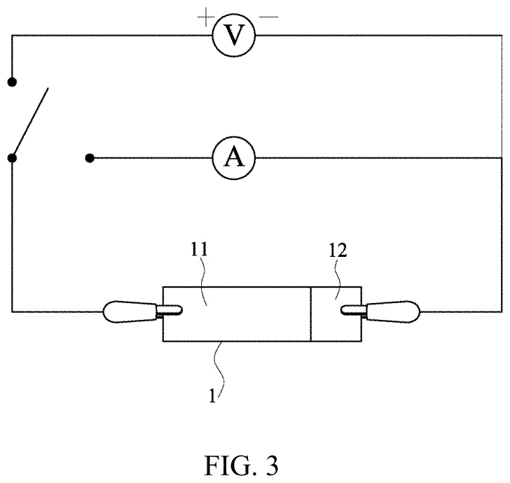

With reference to FIG. 3 for the schematic view of a flexible long-lasting clean energy power generation device in accordance with a preferred embodiment of the present invention, the major difference of the application of this invention and the application of the conventional electrokinetic energy power generation device resides on that this invention just needs to put the flexible long-lasting clean energy power generation device 1 in a general atmospheric environment at general humidity and room temperature in order to spontaneously absorb the moisture in the atmospheric environment, and the moisture in the environment is captured by the moisture absorbent layer 12, and the hydrophilic support substrate 10 and the charged nanochannel wall of the conductive layer 11 will accumulate a large number of counterions, and both sides of the flexible long-lasting clean energy power generation device 1 will have an asymmetric humidity. In other words, an area having the moisture absorbent layer 12 is a wet side, and the other end is a dry side. Now, the moisture forms a capillary pressure gradient due to the effect of the capillary action and evaporation, so that water molecules and counterions on the charged channel wall can move from the wet side to the dry side, so as to generate a streaming potential or a streaming current at both sides of the flexible long-lasting clean energy power generation device 1 for driving the external electronic equipment. Therefore, even in a general humid environment, the side of the flexible long-lasting clean energy power generation device 1 having the moisture absorbent layer 12 can endlessly capture the moisture from the environment, and the device works together with the second section 112 of the conductive layer 11 which is the dry side to make both sides of the flexible long-lasting clean energy power generation device 1 to have the effect of asymmetric humidity, and the capillary pressure difference makes the moisture and ions on the flexible long-lasting clean energy power generation device 1 to move from the wet area to the dry area, and the evaporation can improve the transmission rate of the moisture and ions, so as to achieve the electrokinetic energy power generation application with the long-lasting operation and high-efficiency output effects by spontaneously absorbing moisture from the environment. Since the moisture absorbent layer 12 continuously captures moisture from the atmospheric environment, the flexible long-lasting clean energy power generation device 1 can be stored in a vacuum environment such as a vacuum package or a vacuum box, etc. capable of effectively storing the flexible long-lasting clean energy power generation device 1 when not in use.

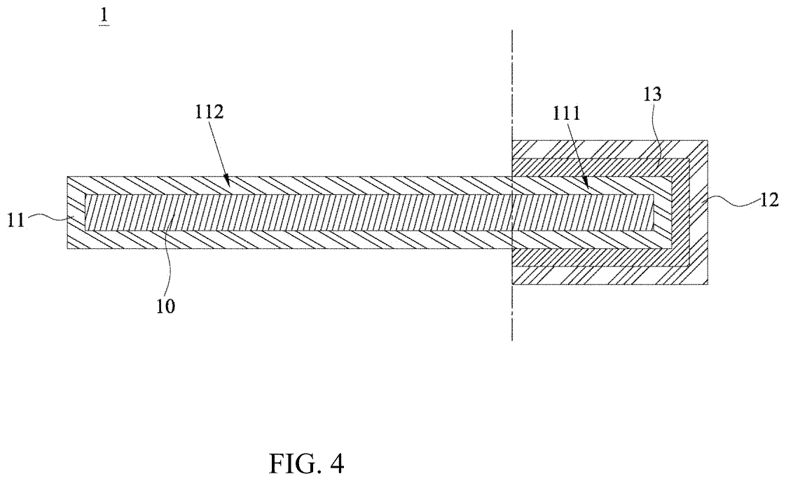

With reference to FIGS. 1, 3 and 4, FIG. 4 is a cross-sectional view of a flexible long-lasting clean energy power generation device in accordance with another preferred embodiment of the present invention, wherein the structure drawn in the figure does not represent the actual thickness, length, width, or scale in order to help readers to clearly understand the technical characteristics of the present invention. In fact, the flexible long-lasting clean energy power generation device of the present invention is a film structure. In the present invention, the flexible long-lasting clean energy power generation device with spontaneous moisture absorption 1 also comprises the hydrophilic support substrate 10, the conductive layer 11 and the moisture absorbent layer 12, and the difference between this embodiment and the previous embodiment resides on that the flexible long-lasting clean energy power generation device 1 of this embodiment further comprises a moisturizing layer 13, and the conductive layer 11 is coated on an other side of the hydrophilic support substrate 10, wherein the conductive layer 11 has a first section 111 and a second section 112. The moisturizing layer 13 is coated on the first section 111 of the conductive layer 11, and the moisture absorbent layer 12 is coated on an outer side of the moisturizing layer 13, so that the flexible long-lasting clean energy power generation device 1 is formed into an asymmetrical structure. The moisture absorbent layer 12 captures moisture in the environment, and the moisture forms a capillary pressure difference due to the effects of capillary action and evaporation, so that water molecules and ions can move from the moisture absorbent layer 12 and the moisturizing layer 13 which are wet areas to the second section 112 which is the dry area, so as to produce a potential difference. In this embodiment, the flexible long-lasting clean energy power generation device 1 is also a layered film structure with two asymmetric sides, and the moisturizing layer 13 is disposed between the conductive layer 11 and the moisture absorbent layer 12 to achieve the effects of locking the moisture and extending the using time effectively. In an example as shown in FIG. 4, the main function of the right side of the flexible long-lasting clean energy power generation device 1 is to absorb moisture from the environment and storing the moisture, and the left side is a relative dry area, and the innermost hydrophilic support substrate 10 can be used as a nanochannel for water transmission under the effect of evaporation and capillary action, and the conductive layer 11 is a nanochannel capable of forming charges on the wall in a water-containing environment, and the moisturizing layer 13 on the right side is hydrophilic and capable of locking the moisture, and slowing down the evaporation of the moisture, and it can be made of a film or a porous material with high water absorbability and water retention, and the moisture absorbent layer 12 on the outer side of the moisturizing layer 13 is provided for capturing the moisture in the atmospheric environment to provide asymmetric humidity to both sides of the flexible long-lasting clean energy power generation device 1. The details of the hydrophilic support substrate 10, the conductive layer 11 and the moisture absorbent layer 12 have been described above, and thus will not be repeated.

Similarly, in practical applications, the flexible long-lasting clean energy power generation device 1 only needs to be put in a general humid environment to capture moisture in the atmospheric environment, so that the moisture absorbent layer 12 can start capturing the moisture from the atmosphere and then condensing the moisture, and the moisturizing layer 13 will play its role of locking water and concentrating the condensed water on a side of the flexible long-lasting clean energy power generation device 1 in order to avoid the asymmetrical humidity on both sides of the flexible long-lasting clean energy power generation device 1 and slow down the excessive evaporation of the moisture. After the moisture is condensed at one side of the flexible long-lasting clean energy power generation device 1, the hydrophilic support substrate 10 and the charged nanochannel wall of the conductive layer 11 will accumulate a large number of counterions, and both sides of the flexible long-lasting clean energy power generation device 1 will have an asymmetric humidity. Now, the moisture will form a capillary pressure gradient due to the effect of the capillary action and evaporation to drive the water molecules and the counterions on the charged channel wall to move from the wet side to the dry side, and both sides of the flexible long-lasting clean wall of the power generation device 1 will generate a streaming potential or a streaming current, so as to drive the external electronic equipment. The operation has been described in details above and thus will not be repeated.

Preferably, the first section 111 has a length equal to 30˜35% of the length of the second section 112, so that the flexible long-lasting clean energy power generation device 1 can form a sufficient humidity difference to improve the overall power generation efficiency. When the first section 111 has a length falling within the range of the aforementioned percentage of the length of the second section 112, the system can ensure that the moisture absorption side can have enough wetness, while maintaining sufficient dry area to form the humidity difference. In a preferred implementation mode, the first section 111 has a length equal to 33% of the length of the second section 112.

In an exemplary embodiment, the aforementioned two structures (which are structures with and without the moisturizing layer respectively) include the hydrophilic support substrate 10 made of the one selected from the group consisting of cellulose paper, cotton cloth and silk cloth with the advantage of low material cost, as well as having an excellent hydrophilic performance. Of course, the hydrophilic support substrate 10 can also be made of other hydrophilic materials having the hydrophilic property and the supporting force. The moisture absorbent layer 12 is made of a material selected from the group consisting of calcium chloride (CaCl₂)), bentonite, silicone, camphor wood and bamboo charcoal, and is capable of achieving the effects of low cost and easy availability, and operating the electrokinetic energy power generation by spontaneously absorbing and transmitting water in ambient humidity. The conductive layer 11 is preferably made of a material selected from the group consisting of zero-dimensional carbon black particle (CB), one-dimensional nano silver wire, carbon nanotube, two-dimensional graphene (G), MXene (two-dimensional transition metal carbide, nitride and carbonitride and capable of achieving the effects of low cost and easy availability. Of course, this also applies to other conductive materials. When the flexible long-lasting clean energy power generation device 1 has the moisturizing layer 13, the moisturizing layer 13 can be made of a MOF material selectively to provide a large specific surface area and active sites, so as to absorb and maintain a great number of moisture from ambient humidity, and provide a long-lasting output of the electrokinetic energy source.

The team of the present invention conducted various experimental tests on the flexible long-lasting clean energy power generation device of the above two asymmetrical states, and the experiment results will be described below. From the experiment results, we can see that the flexible long-lasting clean energy power generation device 1 of this invention has a novel structural characteristic different from the prior art, and surely shows the excellent electrokinetic energy power generation performance and the extremely long use time. In practical applications, the flexible long-lasting clean energy power generation device 1 only needs to be put in a general humid environment to capture moisture in the atmospheric environment in order to achieve the long-lasting and excellent electrokinetic energy power generation effect, so that the device is applicable to the instant power generation requirement under emergency situations. Further, even in an environment with extremely low humidity (RH=20% or so) such as desert, the flexible long-lasting clean energy power generation device 1 can maintain operation and has excellent power generation efficiency, which were supported by the experiment results. In the meantime, the flexible long-lasting clean energy power generation device 1 will not produce any pollutant in the whole power generation process, so that the device conforms to the clean power generation application without bringing adverse effects to the environment. Finally, the flexibility of the flexible long-lasting clean energy power generation device 1 further makes the device to be applicable to wearable devices and highly prospective in the future.

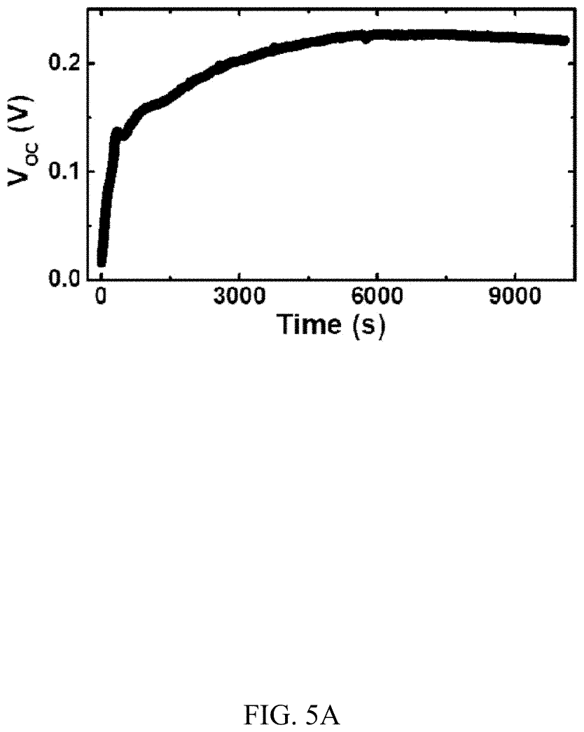

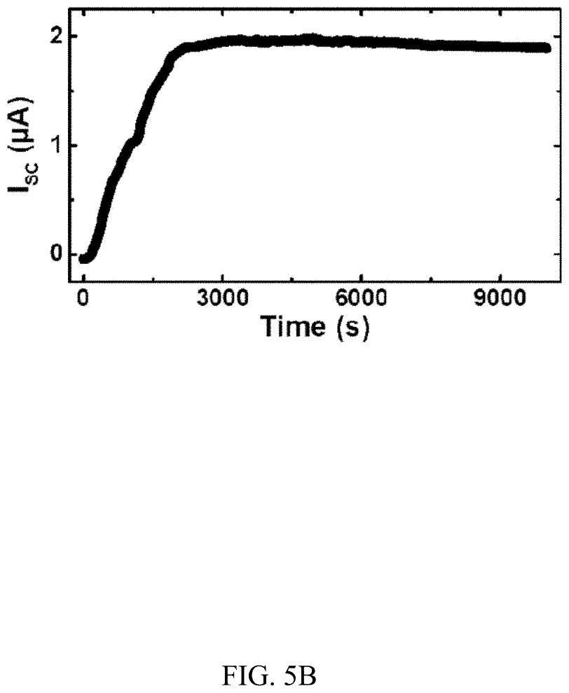

With reference to FIGS. 1, 2, 5A and 5B, FIGS. 5A and 5B show the graphs of the change of statistical data of the open-circuit voltage (V_{OC}) and the short-circuit current (I_{SC}) outputted by flexible long-lasting clean energy power generation device in accordance with the first structural mode of the present invention respectively. In general, current cannot pass through the system under the open circuit condition, so that the V_{OC} outputted by the electrokinetic energy power generation device can be measured. On the other hand, the I_{SC} outputted by the device can be measured under the short circuit condition. The numerical values of both V_{OC} and I_{SC} and the output time can represent the electrokinetic energy power generation performance of the related device. In this experiment, the structure of the flexible long-lasting clean energy power generation device 1 is shown in FIGS. 1 and 2, wherein the hydrophilic support substrate 10 is made of cellulose paper, and the conductive layer 11 is made of zero-dimensional carbon black particles, and the moisture absorbent layer 12 is made of calcium chloride. The experimental results show that when the flexible long-lasting clean energy power generation device 1 of this structure is in contact with the environmental atmosphere (with a relative humidity RH of 50±4%), the V_{OC} and I_{SC} will rise spontaneously and drastically, and the maximum output V_{OC} is approximately 0.22 V, and the maximum output I_{SC} is approximately 2 μA, so that the effect of spontaneously absorbing moisture in the environment to generate the electrokinetic energy power with an excellent power generation efficiency can be achieved. In the meantime, the material for making the flexible long-lasting clean energy power generation device 1 in this manner is very cheap, which is a very cost-effective choice.

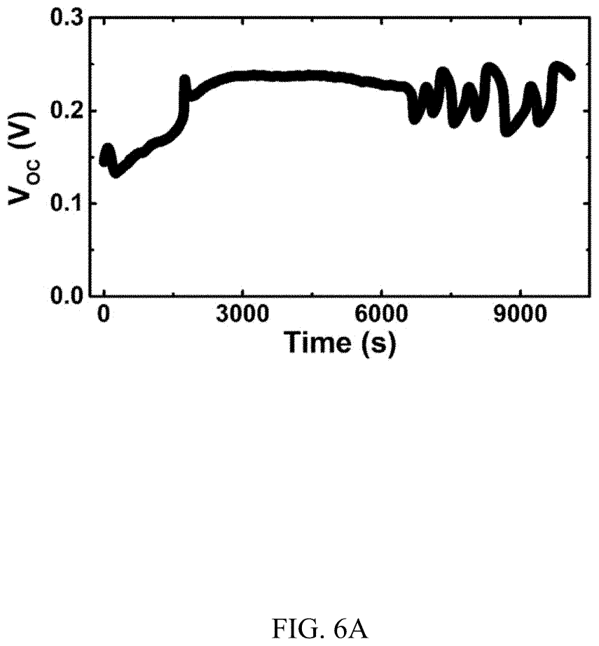

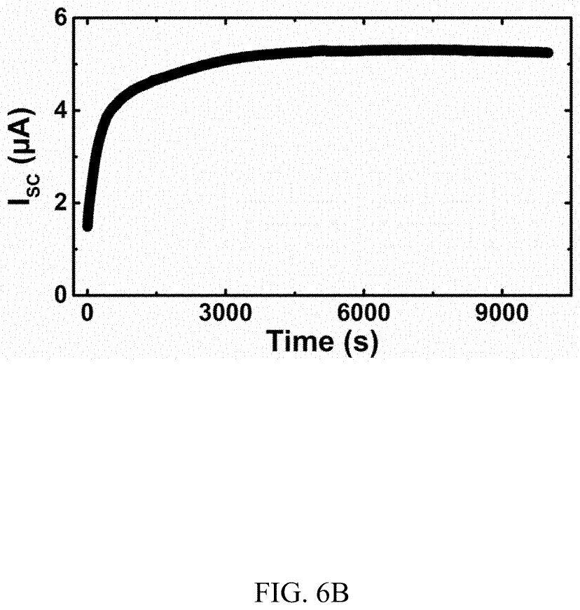

With reference to FIGS. 1, 2, 6A and 6B, FIGS. 6A and 6B are the graphs showing the change of experiment data of the V_{OC} and the I_{SC} in accordance with the second structural mode of the flexible long-lasting clean energy power generation device of the present invention respectively, the impact of different conductive materials on the power generation performance is explored. In this experiment, the structure of the flexible long-lasting clean energy power generation device 1 is shown in FIGS. 1 and 2, wherein the hydrophilic support substrate 10 is made of cellulose paper, the conductive layer 11 is made of two-dimensional graphene, and the moisture absorbent layer 12 is made of calcium chloride. The experiment results show that when the flexible long-lasting clean energy power generation device 1 of this structure is in contact with the environmental atmosphere (relative humidity RH is approximately 50±4%), the V_{OC} and I_{SC} will also rise spontaneously and drastically, and the maximum V_{OC} output is approximately equal to 0.25 V, and the maximum I_{SC} output is approximately equal to 5.3 μA. It is proved that when the material of the conductive layer 11 is substituted by the two-dimensional graphene, the same effect of spontaneously absorbing moisture from the environment of the electrokinetic energy power generation can be achieved.

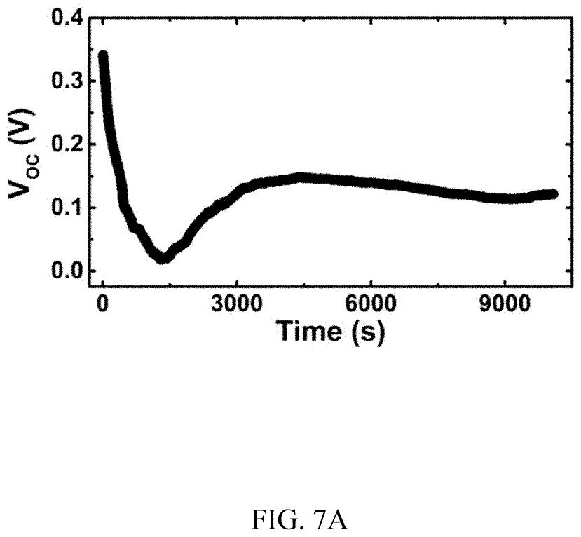

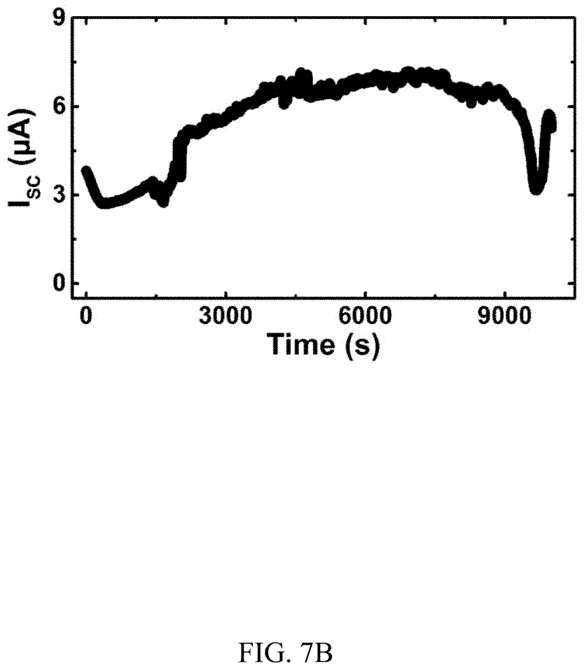

With reference to FIGS. 1, 2, 7A and 7B, FIGS. 7A and 7B are the graphs showing the change of experiment data of the open-circuit voltage V_{OC} and the short-circuit current I_{SC} outputted by a flexible long-lasting clean energy power generation device in accordance with the third structural mode of the present invention respectively, the impact of different hydrophilic substrates on performance is explored. In this experiment, the structure of the flexible long-lasting clean energy power generation device 1 is shown in FIGS. 1 and 2, wherein the hydrophilic support substrate 10 is made of cotton cloth, and the conductive layer 11 is made of zero-dimensional carbon black particles, and the moisture absorbent layer 12 is made of calcium chloride. Experiment results show that when the flexible long-lasting clean energy power generation device 1 is in contact with environmental atmosphere (with a relative humidity RH approximately equal to 50±4%), the average maximum output of V_{OC} is approximately 0.12 V, and the average maximum output of I_{SC} is approximately 6.9 μA, so that substituting the hydrophilic support substrate 10 with the cotton cloth can still achieve the effect of spontaneously absorbing moisture from the environment for the purpose of electrokinetic energy power generation.

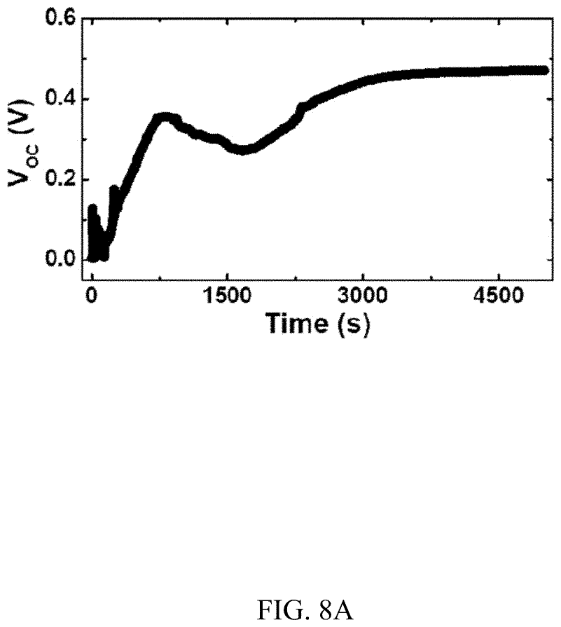

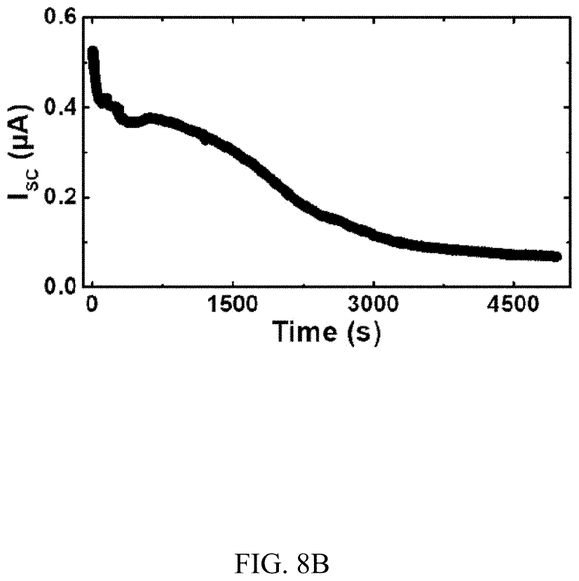

With reference to FIGS. 1, 2, 8A and 8B, FIGS. 8A and 8B are graphs showing the changes of experiment data of the V_{OC} and the I_{SC} outputted by a flexible long-lasting clean energy power generation device in accordance with the fourth structural mode of the present invention respectively, the impact of different hydrophilic substrates on performance is explored. In this experiment, the structure of the flexible long-lasting clean energy power generation device 1 is shown in FIGS. 1 and 2, wherein the hydrophilic support substrate 10 is made of cellulose paper, and the conductive layer 11 is made of zero-dimensional carbon black particles, and the moisture absorbent layer 12 is made of bentonite. Experiment results show that when the flexible long-lasting clean energy power generation device 1 is in contact with environmental atmosphere (with a relative humidity RH approximately equal to 50±4%), the average maximum output of V_{OC} is approximately 0.47 V, and the average maximum output of I_{SC} is approximately 0.52 μA. The environmental moisture absorption capacity of the bentonite in this structural mode is lower than that of calcium chloride, thus leading to an I_{SC} lower than that of the first structural mode, but substituting the material of the hydrophilic absorbent layer 12 with bentonite can still achieve the effect of spontaneously absorbing moisture from the environment for the purpose of electrokinetic energy power generation.

With reference to FIGS. 1, 2, 9A and 9B, FIGS. 9A and 9B are the graphs showing the changes of experiment data of the V_{OC} and the I_{SC} outputted by a flexible long-lasting clean energy power generation device in accordance with the fifth structural mode of the present invention, respectively, the impact of having a moisturizing layer on the performance is explored. In this experiment, the structure of the flexible long-lasting clean energy power generation device 1 is shown in FIG. 4, and this device has the moisturizing layer 13, wherein the hydrophilic support substrate 10 is made of cellulose paper, and the conductive layer 11 is made of zero-dimensional carbon black particles, and the moisture absorbent layer 12 is made of calcium chloride, and the moisturizing layer 13 is made of MOF-808 in a metal organic framework material. Experimental results show that when the flexible long-lasting clean energy power generation device 1 is in contact with environmental atmosphere (with a relative humidity RH approximately equal to 50±4%), the V_{OC} and I_{SC} start rising drastically and spontaneously, and the average maximum output of V_{OC} is approximately 0.49 V, and the average maximum output of I_{SC} is approximately 5.35 μA. More importantly, even this device has operated the power generation for 2 days (or 48 hours), the V_{OC} is still maintained at the level of approximately 0.47 V, and the I_{SC} is still maintained at the level of approximately 4.17 μA, which shows that the electrokinetic energy output is just reduced by 22%, and the device has an excellent long-lasting power generation effect. If the continuous power generation operation of this device is extended to 60 hours, the V_{OC} will still be maintained at the level of approximately 0.41 V, and the I_{SC} will still be maintained at the level of approximately 3.6 μA, which shows that the electrokinetic energy output performance can be maintained at the initial value of 56%. Therefore, the experiment results show that after the addition of the moisturizing layer 13, the output V_{OC} and I_{SC} of the flexible long-lasting clean energy power generation device 1 can be greatly improved, and the power generation operation time can also be extended effectively. The moisturizing layer 13 is very helpful for improving the performance of the flexible long-lasting clean energy power generation device 1.

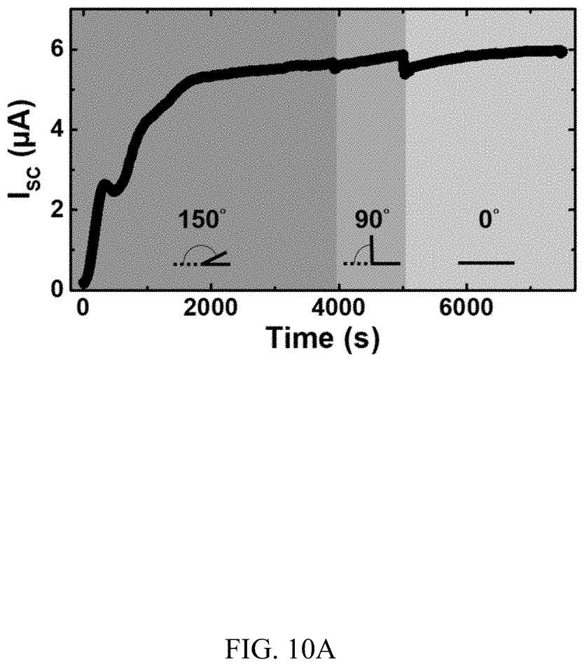

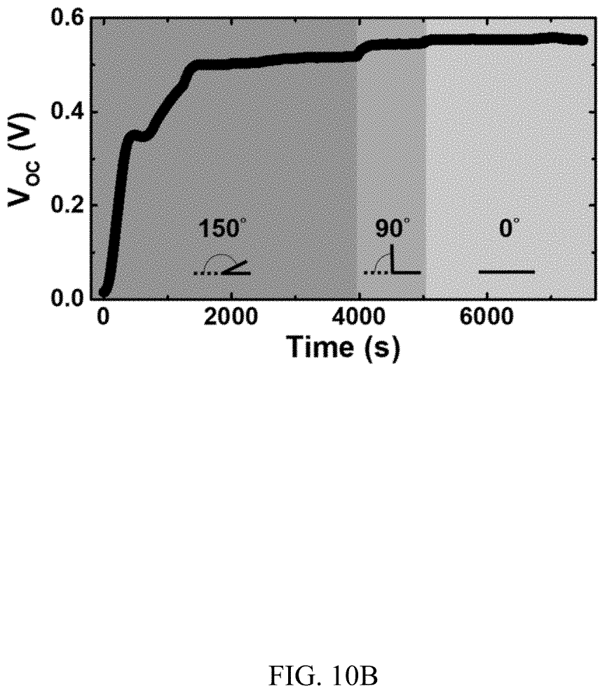

With reference to FIGS. 4, 10A, and 10B, FIGS. 10A and 10B are the graphs showing the change of experiment data of the V_{OC} and the I_{SC} outputted by a flexible long-lasting clean energy power generation device bent at different bending angles in accordance with the fifth structural mode of the present invention respectively, the impact of different bending angles on the power generation performance is explored. In this experiment, the structure of the flexible long-lasting clean energy power generation device 1 is made of the material as described above, wherein the hydrophilic support substrate 10 is made of cellulose paper, and the conductive layer 11 is made of zero-dimensional carbon black particles, and the moisture absorbent layer 12 is made of calcium chloride, and the moisturizing layer 13 is made of MOF-808. Experiment results show that when the bending angle is changed from 150 degrees to 0 degree (which is that flat state as shown in FIG. 3), the V_{OC} and I_{SC} outputted by the flexible long-lasting clean energy power generation device 1 almost have no changes, which shows that the bending state does not affect the performance of the device. It is verified that the flexible long-lasting clean energy power generation device 1 has excellent flexibility and may have high value to the applications on wearable electronic products in the future.

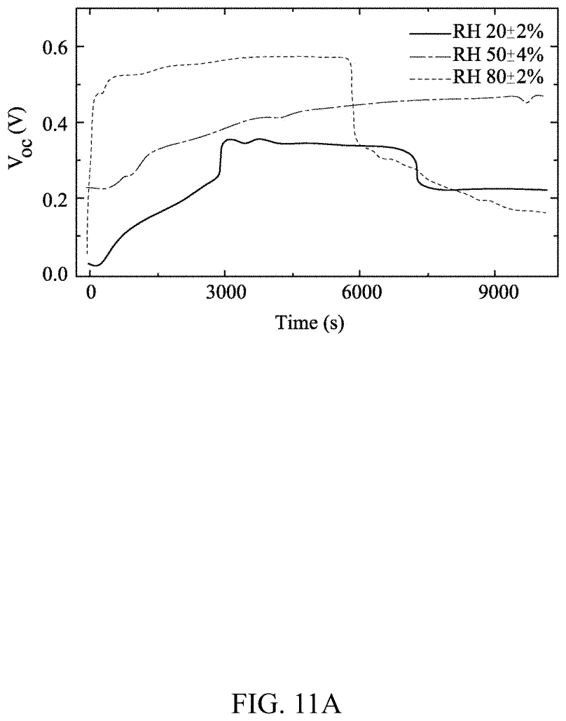

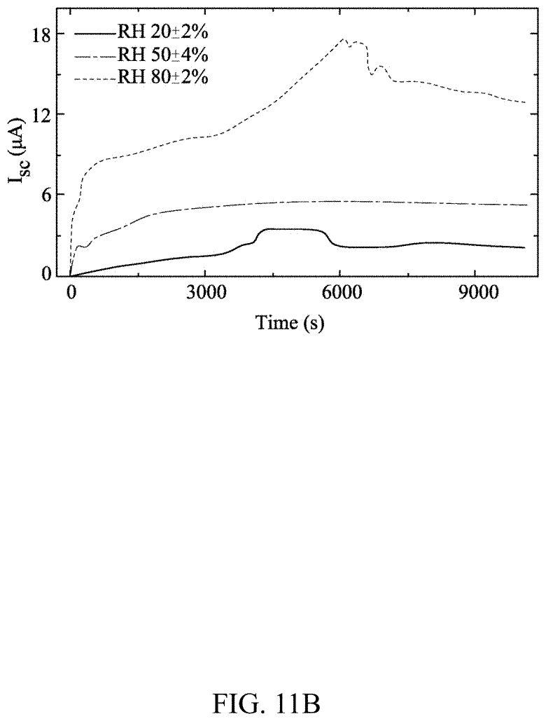

With reference to FIGS. 4, 11A and 11B, FIGS. 11A and 11B are the graphs showing the change of experiment data of the V_{OC} and the I_{SC} outputted by a flexible long-lasting clean energy power generation device bent at different relative humidities in accordance with the fifth structural mode of the present invention respectively. In this experiment, the structure of the flexible long-lasting clean energy power generation device 1 is made of the material as described above, wherein the hydrophilic support substrate 10 is made of cellulose paper, and the conductive layer 11 is made of zero-dimensional carbon black particles, and the moisture absorbent layer 12 is made of calcium chloride, and the moisturizing layer 13 is made of MOF-808. The team of the present invention explored the impact of the relative humidity in the environment on the V_{OC} and I_{SC} outputted by the flexible long-lasting clean energy power generation device 1 and experiment results show that the flexible long-lasting clean energy power generation device 1 regardless of being in contact with the relative humidity of a desert (RH 20±2%), the relative humidity of a general environment (RH 50±4%) or the relative humidity of a mountain or forest (RH 80±2%) can operate normally. When the ambient humidity is extremely low (RH 20±2%), the averaged V_{OC} and I_{SC} can be maintained at a level above 0.2 V and 3 μA, respectively. On the other hand, when the ambient humidity is extremely high (RH 80±2%), the content of moisture in the environment is very high, so that the maximum V_{OC} and I_{SC} outputted by the flexible long-lasting clean energy power generation device 1 can reach up to 0.56 V and 16.1 μA, respectively. These experimental data prove that regardless of a low relative humidity in the desert or a high relative humidity in the forest environment, the present invention can achieve the purpose of spontaneously absorbing moisture from the environment to achieve the purpose of the high-performance electrokinetic energy power generation.

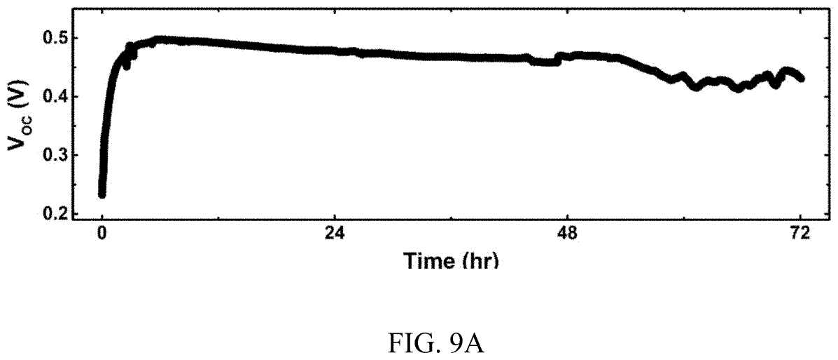

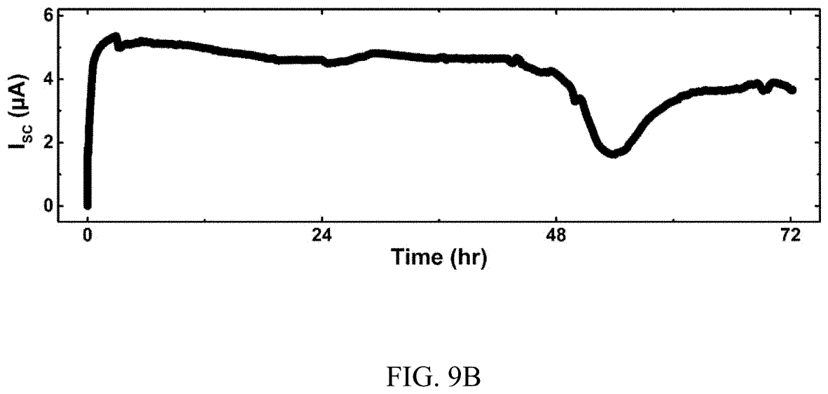

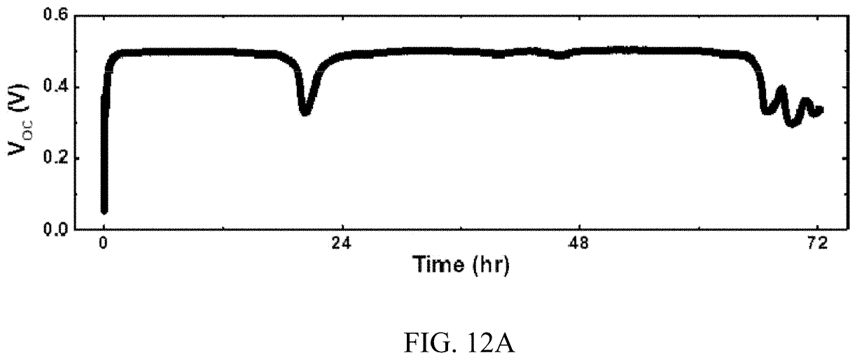

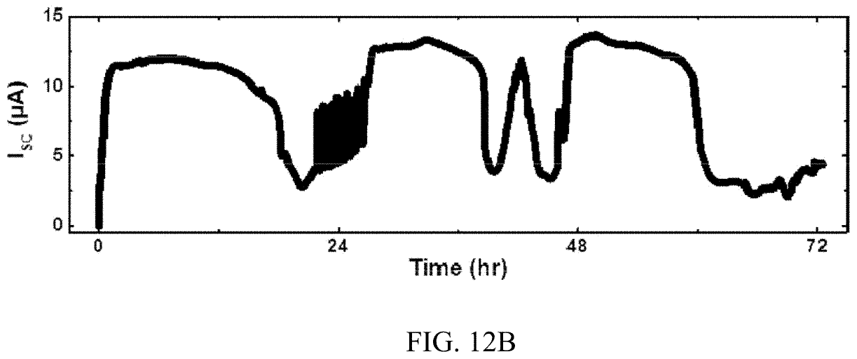

With reference to FIGS. 4, 12A and 12B, FIGS. 12A and 12B are the graphs showing the change of experiment data of the V_{OC} and the I_{SC} outputted by a flexible long-lasting clean energy power generation device in accordance with the sixth structural mode of the present invention, respectively, the impact of different conductive materials on the power generation performance is explored. In this experiment, the structure of the flexible long-lasting clean energy power generation device 1 is shown in FIG. 4, wherein the hydrophilic support substrate 10 is made of cellulose paper, and the conductive layer 11 is made of two-dimensional graphene, and the moisture absorbent layer 12 is made of calcium chloride, and the moisturizing layer 13 is made of MOF-808. Similar to the results as shown in FIGS. 9A and 9B, when the flexible long-lasting clean energy power generation device 1 is in contact with environmental atmosphere (with a relative humidity RH approximately equal to 50±4%), the V_{OC} and I_{SC} start rising drastically and spontaneously. After the device has been operated for 2 days (or 48 hours), even the power generation efficiency may be fluctuated during the operation due to the factors of ambient humidity and temperature, the V_{OC} is still maintained at the level of approximately 0.5 V, and the I_{SC} is still maintained at the level of approximately 13.6 μA finally, and the power generation efficiency and the initial value have a very small difference only. The performance of the V_{OC} and I_{SC} output of this device starts to drop after operating the power generation continuously for 60 hours. Compared with the flexible long-lasting clean energy power generation device 1 of the fifth structural mode, when the two-dimensional graphene is used as the material of the conductive layer 11 in this structural mode, the related electrokinetic energy power generation performance (including V_{OC} and I_{SC}) is higher significantly, and its main reason resides on that the two-dimensional graphene material has better surface conductivity than the zero-dimensional carbon black particles, and the two-dimensional graphene material can form a more ordered nanochannel with the hydrophilic support substrate 10 to avoid the moisture from disappearing too early in the transmission process due to evaporation. When the two-dimensional graphene material is used as the material of the conductive layer 11, it can improve the overall power generation efficiency of the flexible long-lasting clean energy power generation device 1.

In summation of the description above, the present invention provides a novel long-lasting, high-efficiency spontaneous power generation device capable of absorbing moisture from the environment and generating electric power. The device can generate power by absorbing moisture from the environment, as long as the device is put in an environment with an ambient humidity, and there is a humidity source in the environment. The device can generate electric power endlessly to achieve the purpose of sustainable clean energy power generation. The key of success of this device resides on the design of the asymmetric film structure, and the hygroscopic material capable of endlessly capturing the moisture from humid air in the natural environment hydrophilic support substrate. Besides providing a certain degree of flexibility of the film, the hydrophilic support substrate can also form a micro nanochannel with the conductive material for the use of transmitting ions. In addition, the asymmetric film design will also be able to induce evaporation and capillary action through the hydrophilic support substrate and the conductive layer due to the asymmetrical film design that always maintains the other side of the film dry, so as to enhance the electrokinetic energy power output performance.

In order to maintain a stable humidity asymmetry at both sides of the asymmetric film, the present invention also provides a technical solution that adds a moisturizing layer and for the first time introduces a metal organic framework (MOF) material with hydrophilic and water-absorbing properties into the film moisture absorbent layer. The large specific surface area of the porous material is used to achieve the water retention effect, so as to provide a more stable and long-lasting electrokinetic energy power generation output. Since the electrokinetic energy power generation device of the present invention has the advantages of simple manufacture, low-priced and easily available material, no specific environmental limitations on the power generation process, no requirement of additional water source or external pressure gradient field, the device can provide a stable long-lasting and high-performance power generation output in various environments, and it is believed that this device will have a very high commercial value for low-energy electronic equipment in the future.

It is noteworthy that the flexible long-lasting clean energy power generation device of the present invention can be used without much limitation on the using environment, and it can be used in different environments from desert to oasis, or from country to city. Under the environment of normal relative humidity (RH 50±4%), both of the V_{OC} and the I_{SC} outputted from the device have excellent performance.

Even the structure with a moisturizing layer can generate power continuously for more than three days and maintain high stability and performance during the long-lasting output process without significant degradation of the power generation efficiency.

In the era of energy shortage and the concept of promoting green environmental protection, the present invention actually provides a relatively clean and eco-friendly device and achieves a great improvement in power generation efficiency. In addition to the application in wearable devices, the invention can also be combined with fabrics and clothing for use or applied in different low-grade energy equipment. At the same time, in some emergency situations, the flexible long-lasting clean energy power generation device can provide the required basic power directly without requiring any additional resources and the device has excellent applicability in emergency rescue.

What is claimed is:

1. A flexible long-lasting clean energy power generation device with spontaneous moisture absorption, being a multi-layer film structure, and comprising:
a hydrophilic support substrate;
a conductive layer, coated on an outer side of the hydrophilic support substrate, and having a first section and a second section; and
a moisture absorbent layer, coated on the first section of the conductive layer, so that the flexible long-lasting clean energy power generation device is formed into an asymmetrical structure;
thereby, the moisture absorbent layer captures moisture in the environment, and the moisture forms a capillary pressure difference by a capillary action and an evaporation, so that water molecules and ions move from wet area of the moisture absorbent layer to dry area of the second section to form a potential difference.

2. The flexible long-lasting clean energy power generation device according to claim 1, wherein the moisture absorbent layer is made of a material selected from a group consisting of calcium chloride, bentonite, silicone, camphor wood and bamboo charcoal.

3. The flexible long-lasting clean energy power generation device according to claim 1, wherein the conductive layer is made of a material selected from a group consisting of carbon black particle, graphene, MXene, nano silver wire and carbon nanotube.

4. The flexible long-lasting clean energy power generation device according to claim 1, wherein the hydrophilic support substrate is made of a material selected from a group consisting of cellulose paper, cotton cloth and silk cloth.

5. The flexible long-lasting clean energy power generation device according to claim 1, wherein the first section has a length equal to 30˜35% of the length of the second section.

6. The flexible long-lasting clean energy power generation device according to claim 5, wherein the moisture absorbent layer is made of a material selected from a group consisting of calcium chloride, bentonite, silicone, camphor wood and bamboo charcoal.

7. The flexible long-lasting clean energy power generation device according to claim 5, wherein the conductive layer is made of a material selected from a group consisting of carbon black particle, graphene, MXene, nano silver wire and carbon nanotube.

8. The flexible long-lasting clean energy power generation device according to claim 5, wherein the hydrophilic support substrate is made of a material selected from a group consisting of cellulose paper, cotton cloth and silk cloth.

9. A flexible long-lasting clean energy power generation device with spontaneous moisture absorption, being a multi-layer film structure, and comprising:
a hydrophilic support substrate;
a conductive layer, coated on outer side of the hydrophilic support substrate, wherein the conductive layer has a first section and a second section;
a moisturizing layer, coated on the first section of the conductive layer; and
a moisture absorbent layer, coated on outer side of the moisturizing layer, so that flexible long-lasting clean energy power generation device is formed into an asymmetrical structure;
thereby, the moisture absorbent layer captures moisture in the environment, and the moisture forms a capillary pressure difference by a capillary action and an evaporation, so that water molecules and ions move from wet area of the moisture absorbent layer to dry area of the second section to form a potential difference.

10. The flexible long-lasting clean energy power generation device according to claim 9, wherein the moisture absorbent layer is made of a material selected from a group consisting of calcium chloride, bentonite, silicone, camphor wood and bamboo charcoal.

11. The flexible long-lasting clean energy power generation device according to claim 9, wherein the conductive layer is made of a material selected from a group consisting of carbon black particle, graphene, MXene, nano silver wire and carbon nanotube.

12. The flexible long-lasting clean energy power generation device according to claim 9, wherein the moisturizing layer is made of a metal organic framework material.

13. The flexible long-lasting clean energy power generation device according to claim 9, wherein the hydrophilic support substrate is made of a material selected from a group consisting of cellulose paper, cotton cloth and silk cloth.

14. The flexible long-lasting clean energy power generation device according to claim 9, wherein the first section has a length equal to 30˜35% of the length of the second section.

15. The flexible long-lasting clean energy power generation device according to claim 14, wherein the moisturizing layer is made of a metal organic framework material.

16. The flexible long-lasting clean energy power generation device according to claim 14, wherein the moisture absorbent layer is made of a material selected from a group consisting of calcium chloride, bentonite, silicone, camphor wood and bamboo charcoal.

17. The flexible long-lasting clean energy power generation device according to claim 14, wherein the conductive layer is made of a material selected from a group consisting of carbon black particle, graphene, MXene, nano silver wire and carbon nanotube.

18. The flexible long-lasting clean energy power generation device according to claim 14, wherein the hydrophilic support substrate is made of a material selected from a group consisting of cellulose paper, cotton cloth and silk cloth.
